(19) United States
(12) Patent Application Publication
(10) Pub. No.: US 2011/0153927 A1
(43) Pub. Date: Jun. 23, 2011

(54) Storage Control Device, Electronic Device, and Storage Control Method

(76) Inventor: Takami SUGITA, Tokyo (JP)

(21) Appl. No.: 12/878,604

(22) Filed: Sep. 9, 2010

(30) Foreign Application Priority Data
Dec. 18, 2009 (JP) 2009-288073

(51) Int. Cl. G06F 12/00

(52) U.S. Cl. 711/106; 711/105; 711/E12.001

(57) ABSTRACT

According to one embodiment, a storage control device includes a controller, a detector, and a refreshing module. The controller writes image data, which is to be output to a display module, to a storage device and outputs the image data from the storage device to the display module. The detector detects a blanking period during which the controller does not write the image data to the storage device and does not output the image data from the storage device to the display module. The refreshing module refreshes the storage device by rewriting the image data to the storage device at a predetermined time interval if the detector detects a blanking period.

### CROSS-REFERENCE TO RELATED APPLICATIONS

This application is based upon and claims the benefit of priority from Japanese Patent Application No. 2009-288073, filed Dec. 18, 2009, the entire contents of which are incorporated herein by reference.

### FIELD

Embodiments described herein relate generally to a storage control device, an electronic device, and a storage control method.

### BACKGROUND

There have been used large scale integrations (LSIs) to read/write image data from/to a storage device such as a dynamic random access memory (DRAM) that needs refreshing to store image data to be displayed on a display device. Such an LSI periodically performs refresh operation upon reading/writing image data from/to a storage device. Therefore, when image data stored in a storage device is output to a display device, unnecessary refresh operation is performed while the image data is being read/written from/to the storage device. This degrades the performance to display the image data on the display device.

For example, there is a conventional technology to perform refresh operation without degrading the performance to display image data on a display device. According to the conventional technology, refresh operation is performed only in a blanking period in which image data is not displayed on the display device to avoid unnecessary refresh operation from being performed while the image data is being read/written from/to a storage device. Thus, it is made possible to effectively use the performance of accessing the storage device.

With the conventional technology, refresh operation is continuously performed in the blanking period regardless of the necessity. This refresh operation increases the power consumption.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a television (TV) device according to an embodiment;

FIG. 2 is an exemplary schematic diagram for explaining the timing of outputting image data to a panel in the embodiment;

FIG. 3 is an exemplary schematic diagram for explaining the timing of performing refresh operation in the embodiment; and

FIG. 4 is an exemplary flowchart of the refresh operation in the embodiment.

### DETAILED DESCRIPTION

In general, according to one embodiment, a storage control device includes a controller, a detector, and a refreshing module. The controller is configured to write image data, which is to be output to a display module, to a storage device and output the image data from the storage device to the display module. The detector is configured to detect a blanking period during which the controller does not write the image data to the storage device and does not output the image data from the storage device to the display module. The refreshing module is configured to refresh the storage device by rewriting the image data to the storage device at a predetermined time interval if the detector detects a blanking period.

According to another embodiment, an electronic device includes a display module, a storage module, a controller, a detector, and a refreshing module. The storage module is configured to store image data to be output to the display module. The controller is configured to write the image data to the storage device and output the image data from the storage device to the display module. The detector is configured to detect a blanking period during which the controller does not write the image data to the storage device and does not output the image data from the storage device to the display module. The refreshing module is configured to refresh the storage device by rewriting the image data to the storage device at a predetermined time interval if the detector detects a blanking period.

According to still another embodiment, there is provided a storage control method applied to a storage control device. The storage control method comprises: a controller writing image data, which is to be output to a display module, to a storage device and outputting the image data from the storage device to the display module; a detector detecting a blanking period during which the controller does not write the image data to the storage device and does not output the image data from the storage device to the display module; and a refreshing module refreshing the storage device by rewriting the image data to the storage device at a predetermined time interval if the detector detects a blanking period.

While the storage control device according to an embodiment is described herein as being applied to a television (TV) device, this is by way of example and not limitation. The storage control device may be applied to any other electronic device.

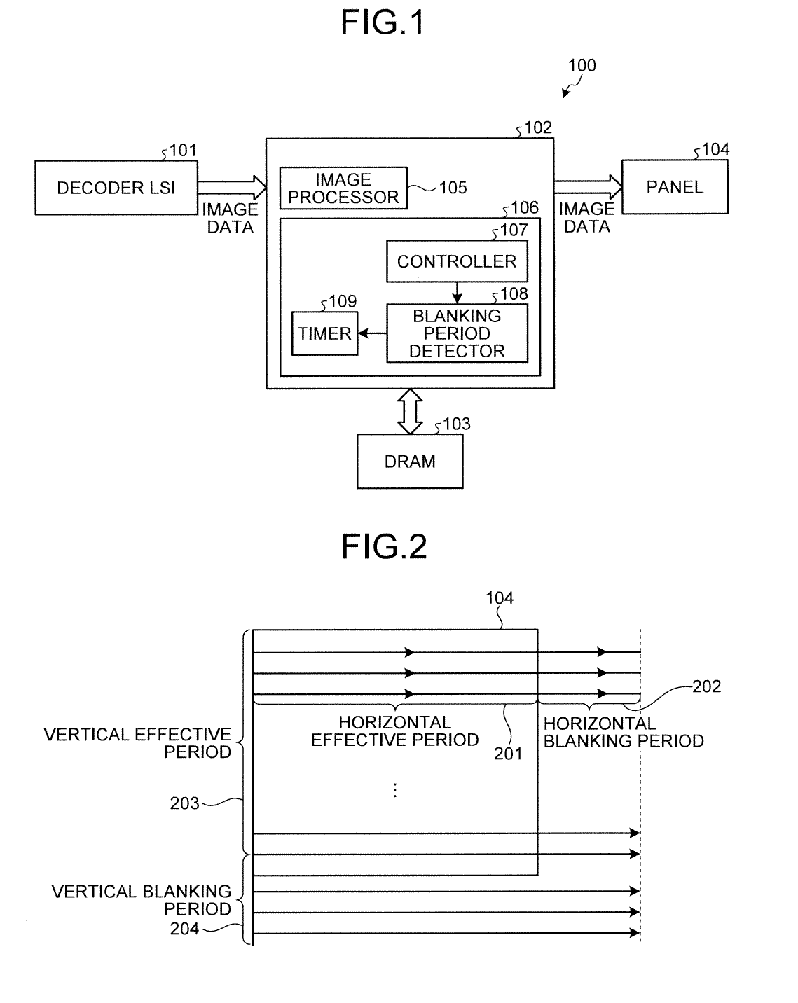

FIG. 1 is a block diagram of a TV device 100 according to an embodiment. As illustrated in FIG. 1, the TV device 100 of the embodiment comprises a decoder large scale integration (LSI) 101 for receiving digital broadcasting, a TV system LSI 102, a dynamic random access memory (DRAM) 103, and a panel 104.

The panel 104 (display module) comprises a flat panel display such as, for example, a liquid crystal display (LCD) or a plasma display, and displays image data.

The DRAM 103 (storage device) stores image data to be output to the panel 104. Refresh operation is performed on the DRAM 103 and image data written thereto is rewritten to prevent the loss of the image data due to the lapse of time. While the storage device of the embodiment is described as the DRAM 103, it is not limited thereto, and may be a double data rate 2 (DDR2), a synchronous dynamic random access memory (SDRAM), or the like.

The decoder LSI 101 comprises a transport stream multiplexer (TS Demux) and an AV decoder. The TS Demux performs error correction and descrambling on a digital TV broadcast signal output from a tuner (not illustrated), and converts it into transport stream (TS) packets. The TS Demux demultiplexes the transport stream to obtain a video signal packet (image data) from the packets. The AV decoder performs decoding on the image data received from the TS Demux based on, for example, the moving picture coding experts group (MPEG) compression coding.

The TV system LSI 102 comprises an image processor 105 and a memory controller 106 (storage control device). With respect to the image data decoded by the decoder LSI 101, the image processor 105 performs image processing such as super resolution conversion to enhance the resolution of the image data while maintaining the sharpness thereof. For example, the image processor 105 estimates proper pixel values from low resolution image data and interpolates pixels to create high resolution image data.

The memory controller 106 comprises a controller 107, a blanking period detector 108, and a timer 109.

The controller 107 writes image data (image data to be output to the panel 104), on which the image processor 105 has performed image processing, to the DRAM 103. The controller 107 also outputs the image data from the DRAM 103 to the panel 104.

The blanking period detector 108 detects a blanking period (blanking period start and blanking period end) during which the controller 107 does not write image data to the DRAM 103 and does not output image data from the DRAM 103 to the panel 104.

For example, the blanking period detector 108 detects a vertical blanking period or a horizontal blanking period during which the controller 107 does not write image data to the DRAM 103 and does not output image data from the DRAM 103 to the panel 104.

With reference to FIG. 2, a description will be given of the timing of outputting image data to the panel 104. FIG. 2 illustrates the timing of outputting image data to the panel 104. As illustrated in FIG. 2, a horizontal effective period 201 is a period (the number of pixels) to output image data for one horizontal line of the panel 104. For example, in the case of 1920×1080 resolution, the horizontal effective period 201 is fixed to 1920 pixels. A horizontal blanking period 202 is a period for preparation to output image data of the next horizontal line. The horizontal blanking period 202 can be changed to a certain extent if necessary.

A vertical effective period 203 is a period (the number of lines) to output image data for one screen of the panel 104. For example, in the case of 1920×1080 resolution, the vertical effective period 203 is fixed to 1080 lines. A vertical blanking period 204 is a period for preparation to output image data of the next screen. The vertical blanking period 204 can be changed to a certain extent if necessary.

The blanking period detector 108 may detect as a blanking period a period during which image data is not written to the DRAM 103 and image data is output from the DRAM 103 to the panel 104 (i.e., a period in which image data is not received from the decoder LSI 101). With this, if no image data is received from the decoder LSI 101, it is possible to prevent the loss of image data written to the DRAM 103. Thus, the output of the same image data to the panel 104 can be continued.

Besides, the blanking period detector 108 detects an image processing access period. The term “image processing access period” as used herein refers to a period in which a memory access is made to write image data having undergone image processing by the image processor 105 to the DRAM 103 and to output the image data from the DRAM 103 to the panel 104.

When the blanking period detector 108 detects a blanking period, the timer 109 refreshes the DRAM 103 at regular intervals. In this manner, refresh operation is not performed while image data is being written to the DRAM 103 and is being output from the DRAM 103 to the panel 104. Thus, it is made possible to make the best use of the performance of accessing the DRAM 103, and thereby to improve the performance to display image data on the panel 104. Moreover, it is possible to avoid unnecessary refresh operation from being performed in a blanking period detected by the blanking period detector 108. Thus, refresh operation consumes less power.

The regular intervals are determined according to the specification of the DRAM 103. Preferably, the regular intervals correspond to the time after the lapse of which image data written to the DRAM 103 is lost. With this, only minimum necessary refresh operation is performed during a blanking period. Thus, it is possible to further reduce the power consumed by refresh operation performed on the DRAM 103.

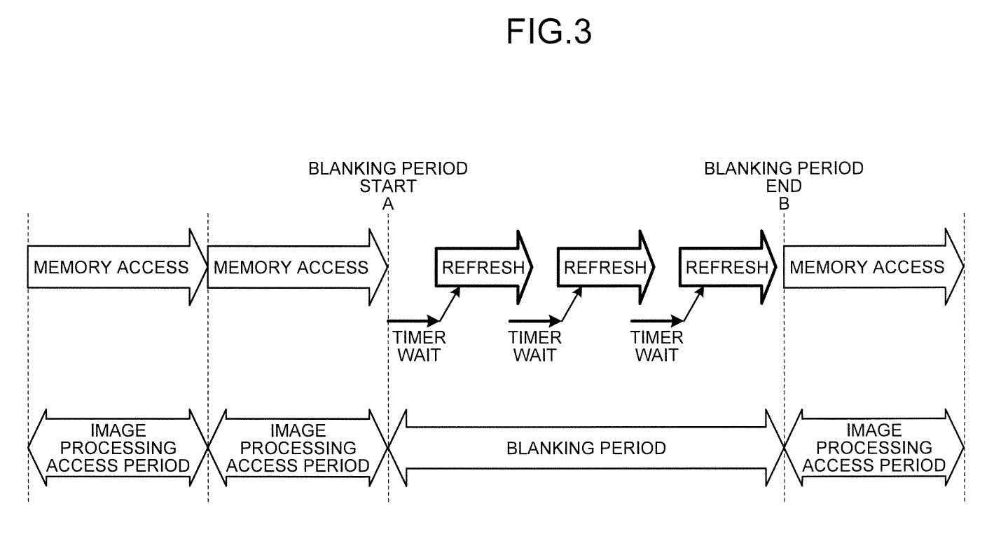

FIG. 3 illustrates the timing of performing refresh operation. As illustrated in FIG. 3, the blanking period detector 108 detects an image processing access period in which a memory access is made to write image data having undergone image processing by the image processor 105 to the DRAM 103 and to output the image data from the DRAM 103 to the panel 104. While an image processing access period is being detected by the blanking period detector 108, the timer 109 is in standby mode without performing refresh operation on the DRAM 103.

When the blanking period detector 108 detects a blanking period start A after the image data having undergone image processing by the image processor 105 is written to the DRAM 103, the image data is output from the DRAM 103 to the panel 104, and thereby the memory access is completed, the timer 109 counts a predetermined time and waits to perform refresh operation. Each time having counted the predetermined time, the timer 109 refreshes the DRAM 103.

Thereafter, when a memory access is made to write image data having undergone image processing by the image processor 105 to the DRAM 103 and to output the image data from the DRAM 103 to the panel 104, and the blanking period detector 108 detects a blanking period end B, the timer 109 enters standby mode again. While an image processing access period is being detected by the blanking period detector 108, the timer 109 is in standby mode without performing refresh operation on the DRAM 103.

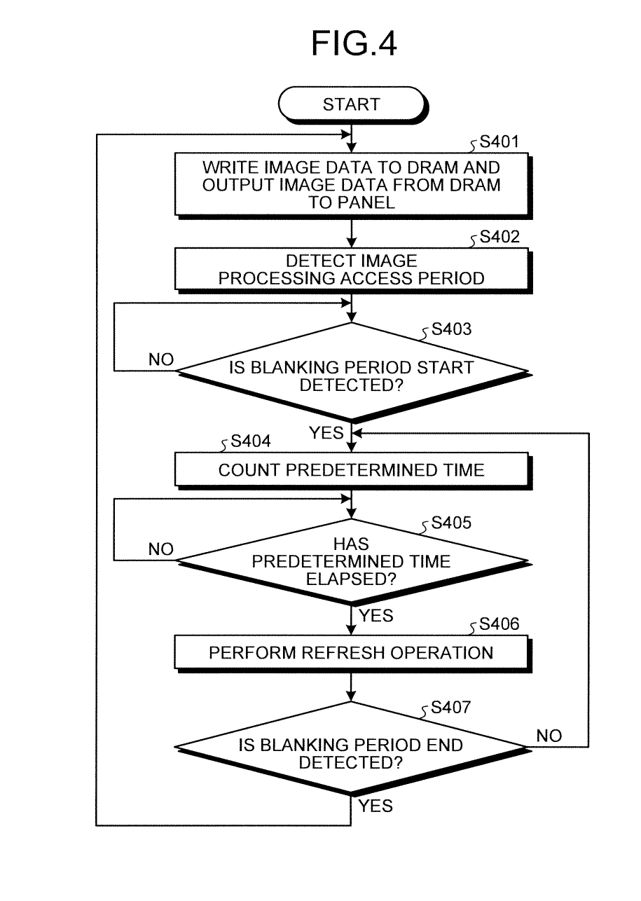

FIG. 4 is a flowchart of the refresh operation. As illustrated in FIG. 4, while image data is being received from the decoder LSI 101, the controller 107 writes image data having undergone image processing by the image processor 105 to the DRAM 103 and outputs image data from the DRAM 103 to the panel 104 (S401).

The blanking period detector 108 detects, as an image processing access period, a period during which the controller 107 writes image data having undergone image processing by the image processor 105 to the DRAM 103 and outputs the image data from the DRAM 103 to the panel 104 (S402).

The blanking period detector 108 detects the end of the image processing access period and the start of a blanking period (Yes at S403). Then, the timer 109 starts counting a predetermined time (S404).

After the predetermined time has elapsed (Yes at S405), the timer 109 performs refresh operation on the DRAM 103 (S406). The timer 109 repeatedly counts the predetermined time and performs refresh operation until the blanking period detector 108 detects the end of the blanking period (S407).

When the blanking period detector 108 detects the end of the blanking period (Yes at S407), the timer 109 terminates the counting of the predetermined time and refresh operation, and the process returns to S401. Accordingly, the controller 107 again writes image data having undergone image processing by the image processor 105 to the DRAM 103 and outputs the image data from the DRAM 103 to the panel 104 (S401).

As described above, according to the embodiment, in the TV device 100, the image processor 105 performs image processing on image data to be written to the DRAM 103. The image data is output from the DRAM 103 to the panel 104. The blanking period detector 108 detects a blanking period during which the image data is not written to the DRAM 103 and is not output from the DRAM 103 to the panel 104. Upon detection of a blanking period, the DRAM 103 is refreshed at regular intervals. In this manner, refresh operation is not performed while image data is being written to the DRAM 103 and is being output from the DRAM 103 to the panel 104. Thus, it is made possible to make the best use of the performance of accessing the DRAM 103, and thereby to improve the performance to display image data on the panel 104. Moreover, it is possible to avoid unnecessary refresh operation from being performed in a blanking period detected by the blanking period detector 108. Thus, refresh operation consumes less power.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage control device comprising:
a controller configured to write image data, which is to be output to a display module, to a storage device and output the image data from the storage device to the display module;
a detector configured to detect a blanking period during which the controller does not write the image data to the storage device and does not output the image data from the storage device to the display module; and
a refreshing module configured to refresh the storage device by rewriting the image data to the storage device at a predetermined time interval if the detector detects a blanking period.

2. The storage control device of claim 1, wherein the predetermined time interval corresponds to a time period upon lapse of which the image data written to the storage device is lost.

3. The storage control device of claim 1, wherein the controller is configured to write the image data, on which image processing has been performed, to the storage device.

4. The storage control device of claim 1, wherein the storage device is a dynamic random access memory.

5. An electronic device comprising:
a display module;
a storage module configured to store image data to be output to the display module;
a controller configured to write the image data to the storage device and output the image data from the storage device to the display module;
a detector configured to detect a blanking period during which the controller does not write the image data to the storage device and does not output the image data from the storage device to the display module; and
a refreshing module configured to refresh the storage device by rewriting the image data to the storage device at a predetermined time interval if the detector detects a blanking period.

6. A storage control method applied to a storage control device, comprising:
a controller writing image data, which is to be output to a display module, to a storage device and outputting the image data from the storage device to the display module;
a detector detecting a blanking period during which the controller does not write the image data to the storage device and does not output the image data from the storage device to the display module; and
a refreshing module refreshing the storage device by rewriting the image data to the storage device at a predetermined time interval if the detector detects a blanking period.
